(19) United States
(12) Patent Application Publication
(10) Pub. No.: US 2026/0229893 A1
(43) Pub. Date: Aug. 6, 2026

(54) INITIALIZING AND OPERATING A BUS SYSTEM

(71) Applicant: BSH HAUSGERÄTE GMBH, München (DE)

(72) Inventors: Kai Achim KROPP, Wald (DE); Martin WINKLER, Nittenau (DE)

(21) Appl. No.: 19/147,425

(22) PCT Filed: Mar. 13, 2024
(86) PCT No.: PCT/EP2024/056614

§ 371 Date: Jul. 11, 2025

(30) Foreign Application Priority Data
Mar. 15, 2023 (DE) 10 2023 202 331.8

(51) Int. Cl. H02J 3/007; G06F 13/37

(52) U.S. Cl. CPC H02J 3/007; G06F 13/37; G06F 2213/40

(57) ABSTRACT

A system includes a primary electronic module and at least one secondary electronic module. The secondary modules are connected to the primary module in the manner of a daisy chain by a signal line. A method for initializing such a system includes a) opening the signal line in all secondary modules, b) providing an initialization signal on the signal line through the primary module, c) initializing a secondary module, which receives the initialization signal and is not yet initialized, d) closing the signal line through the last initialized secondary module, and e) repeating the steps b) to d) until all secondary modules are initialized. An electronic module and an electrical appliance having the system, are also provided.

The present invention relates to a bus system having multiple electronic modules. In particular, the invention relates to the operation of such a bus system.

An appliance, for example a domestic appliance or a motor vehicle, comprises a system having multiple electronic modules which are connected to one another by means of a serial bus. The system can control the appliance or a part thereof. A predetermined bus protocol regulates the access to the common medium and the transmission of data from one sender to one or more receivers. For this purpose, each module can be configured with a unique communication address and fulfill a predetermined purpose within the appliance or motor vehicle.

If the system is to be reconfigured, by way of example by removing a module from the system, adding a module to the system or changing the position of a module in the surrounding appliance, it is necessary to distribute appropriate information to the remaining modules of the system. Different proposals have been made to configure the modules dynamically in the system, wherein the system establishes its operability within a configuration phase. In this case, a primary module can control the sequence of the initialization phase and create an overview regarding the topography of the system. Secondary modules can communicate with the primary module and process their respective configurations.

In order to initialize such a bus system in a rapid and reliable manner, one or more dedicated lines may be required. These can increase the complexity or susceptibility to errors of the system. In addition, such lines may not have a function after the initialization phase, so that the effort required only for the initialization may be too high.

An object of the present invention is to provide an improved technique for initializing a system having a primary and at least one secondary electronic module. The invention achieves this object by means of the subjects of the independent claims. Subordinate claims reflect preferred embodiments.

A system comprises a primary and at least one secondary electronic module, wherein the secondary modules are connected to the primary module by means of a signal line in the manner of a daisy chain. A method for initializing such a system comprises the following steps:
a) open the signal line in all secondary modules;
b) provide an initialization signal on the signal line through the primary module;
c) initialize a secondary module which receives the initialization signal and is not yet initialized;
d) close the signal line through the last initialized secondary module; and
e) repeat the steps b) to d) until all secondary modules are initialized.

The signal line is looped from the primary module through all designated secondary modules in sequence in the manner of a daisy chain. Each of the secondary modules can interrupt or close the signal line. If the signal line to a secondary module is open, all further secondary modulates remote from the first module are separated from it. It is possible using the described procedure to predetermine a sequence in which the secondary modules are initialized due to their position in the signal line. The secondary modules are initialized one after the other so that conflicts, by way of example as a result of data collision, can be excluded.

It is preferred that the initialization of a secondary module includes its communication with the primary module. It is preferred that during the initialization of the secondary module the primary module can collect information regarding its arrangement on the signal line. In the opposite direction, the primary module distributes predetermined information or resources to the secondary module. Information which can be transmitted from a secondary module to the primary module can include, for example, an identification, a function, a position, a version or a feature. Information which can be transmitted in the opposite direction from the primary module to the initializing secondary module includes, for example, a configuration or a position of the secondary module in the system.

Optionally, a software component of the secondary module can be updated from the primary module. For this purpose, it is initially possible in terms of communication to establish that the secondary module uses a software component for which an update is available from the primary module. Subsequently, the actualization can be transmitted from the primary module to the secondary module and activated there. The initialization of the secondary module can be subsequently continued.

If during a predetermined time period after the provision of an initialization signal there is no communication between the primary module and a secondary module which is not yet initialized, the initialization of the system can be terminated. This condition usually occurs when all secondary modules of the system are initialized. If a secondary module cannot be initialized, it can still close the signal line in order to enable initialization of a secondary module further away from the primary module on the signal line. The primary module can detect if one or more secondary modules have not been initialized. It can be determined whether the system has been reconfigured from a last known state or whether there is a fault condition in which part of the system is not functioning. The primary module can then initiate an appropriate measure in order to respond to the decision made. The measure can include in particular providing an error message.

The secondary module can be connected to the primary module by means of a data bus in addition to the signal line. In this case, the primary module can communicate with an initialized secondary module via the data bus. The data bus is preferably configured in series so that a number of lines can be small. By way of example, the data bus can include a CAN bus or a similar bus. In another embodiment, the signal line can be configured as a single wire bus and communication takes place via the signal line. If initialization of the system is complete, communication between the modules takes place mainly on the data bus.

In a further embodiment, the communication includes transmitting a configuration from the secondary module to the primary module. In this case, the primary module determines, on the basis of received configurations, a topology of secondary modules in the system.

If all secondary modules in the system are initialized, the signal line runs from the primary module through all secondary modules one after the other. The signal line can have further uses in a subsequent phase. In particular, once all modules are initialized, the signal line can connect one of the modules to a predetermined potential in order to provide an interrupt request. The interrupt request can be provided in particular if the module determines an error condition which it cannot eliminate itself. Usually, the interrupt request is transmitted from the secondary module to the primary module. The primary module can then perform a higher-level function or send a signal to a coordinate or higher-level facility.

According to a further aspect of the present invention, a primary electronic module comprises an output for connecting to a signal line in the manner of a daisy chain; and a processing facility which is configured so as via the signal line to provide an initialization signal to at least one secondary electronic module. Moreover, the primary electronic module can be configured for connecting to a data bus, wherein the data bus is connected to the secondary module. As a result, the primary module can communicate with a secondary electronic module once the primary module has provided the initialization signal to the secondary module. The communication can control the initialization of the secondary module.

According to a further aspect of the present invention, a secondary electronic module comprises an input and an output for a signal line in the manner of a daisy chain; a switch between the input and the output; and a processing facility which is configured so as when the switch is open to detect an initialization signal at the input, to initialize the secondary electronic module; and to close the switch. One or more secondary electronic modules can cooperate with a primary electronic module described herein.

The secondary electronic module can also have a further switch for connecting the signal line to a predetermined potential in order to provide an interrupt request. In this case, the further switch is preferably connected to the output so that the interrupt request can only be forwarded to the primary module if the switch between the output and the input is closed. This allows the initialization of the secondary electronic module to be improved and carried out without disruption. In another embodiment, the further switch can also be connected to the input if it is desired that an interrupt request can also be provided during the initialization of the secondary module.

A system comprises a primary electronic module described herein and at least one secondary electronic module described herein and a signal line which connects the secondary module to the primary module in the manner of a daisy chain. In addition, a data bus can be provided to which the modules are connected. The data bus may in particular comprise a serial data bus which is constructed in the manner of a single-wire or multi-wire connection. The data bus cannot support or assume any physical sequence of participants on the medium.

The system or one of its modules can be configured so as to perform in part or completely a method described herein. For this purpose, the system or one of its modules can comprise a processing facility which is designed in particular electronically and comprises a programmable microcomputer or microcontroller, for example. The method can be in the form of a computer program product with program code means. The computer program product can also be stored on a computer-readable data carrier. Features or advantages of the method can be transferred to the system or to one of its modules, or vice versa.

The technique described herein can be used advantageously in particular if multiple similar or identical secondary modules are used in the system. Thus, for example, a position of one of the modules on the signal line can be changed and, during a subsequent initialization phase of the system, the secondary modules can be configured in such a manner that the change will be compensated.

According to one aspect of the present invention, an electrical appliance comprises a system described herein. The appliance can comprise in particular a domestic appliance or a motor vehicle.

In an illustrative example of a proposed system, secondary modules on board a motor vehicle can each implement a direction indicator (turn signal). Starting from the primary module, the signal line can be routed sequentially to secondary modules to provide a flashing signal at the front left, front right, rear right, and rear left of the motor vehicle. If the first two secondary modules of the system are swapped with each other, they can be adapted during a subsequent initialization phase of the system to their new functions since it is known on the part of the primary module in which sequence the signal line runs through the secondary modules. The first initialized secondary module (the last one front right) can be initialized for the position front left and the second secondary module (the last one front left) can be initialized for the position front right. The remaining secondary modules for the rear right and rear left positions have not changed their positions on the signal line, so that their configurations can remain unchanged.

The invention is now described in detail with regard to the attached figures, in which:

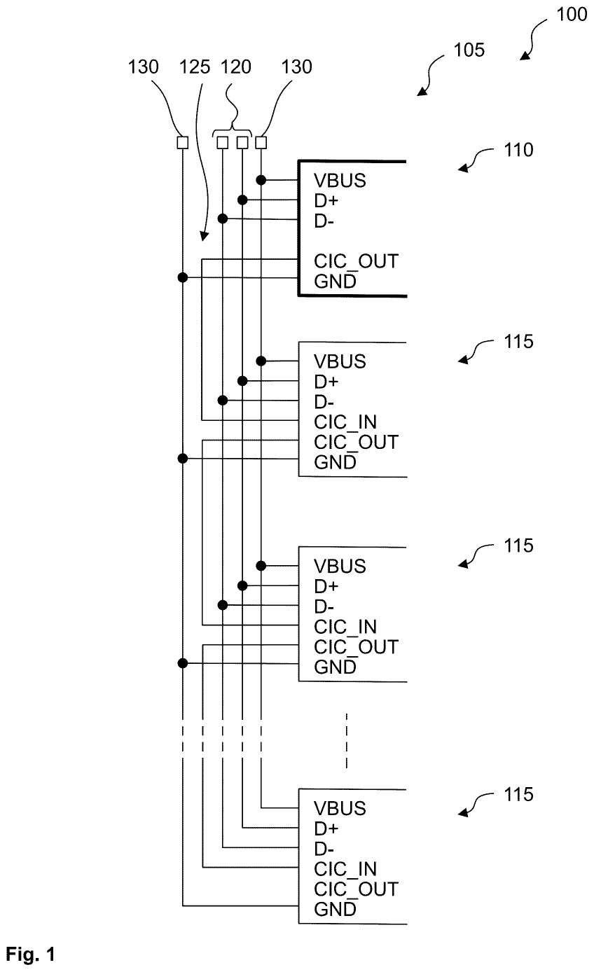

FIG. 1 shows a system;

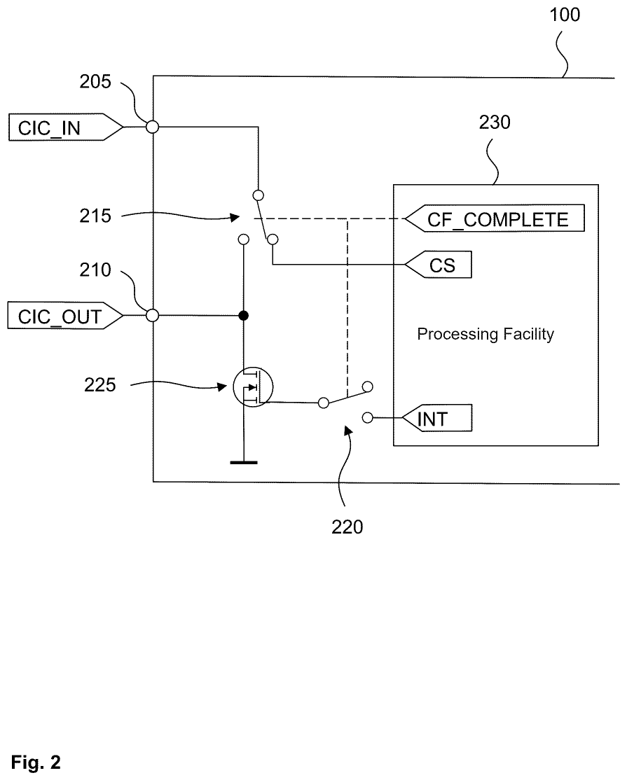

FIG. 2 shows an electronic module; and

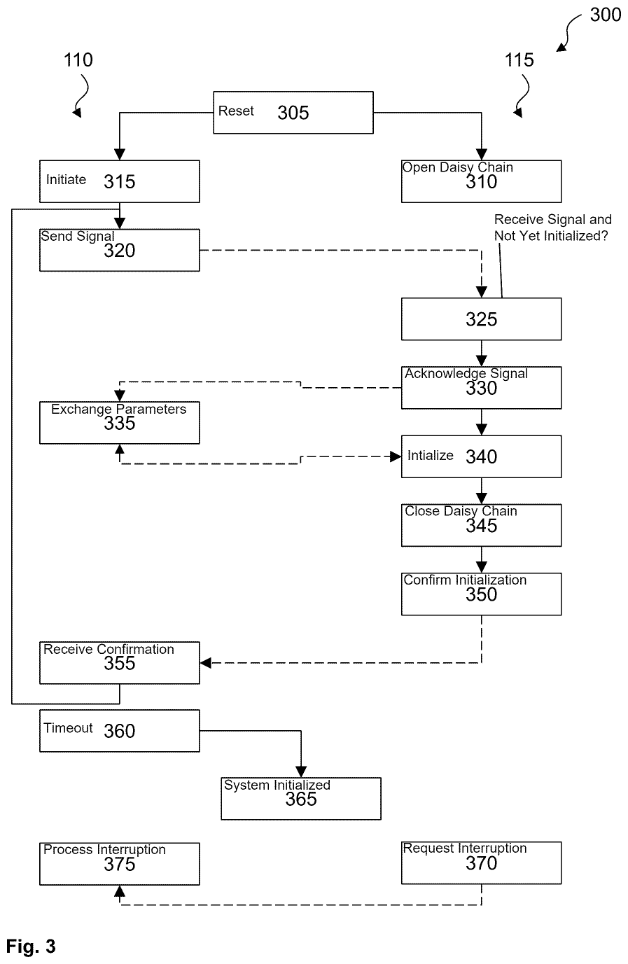

FIG. 3 shows a flow diagram of a method.

FIG. 1 shows an appliance 100 having an electronic system 105. The system 105 comprises a primary electronic module 110 and multiple secondary electronic modules 115. The modules 110, 115 are preferably connected to one another by means of a data bus 120. The data bus 120 is preferably organized in a serial manner and in the present case is designed purely by way of example as a CAN bus. In addition, a signal line 125 is provided which runs from the primary module 110 through all secondary modules 115 in a predetermined sequence in the manner of a daisy chain. Furthermore, the modules 110, 115 can be connected to an energy source by means of supply lines 130.

The system 105 can comprise in practice any number of secondary modules 115. A sequence in which the secondary modules 115 lie on the signal line 125 can determine a sequence in which the secondary modules 115 are initialized. The initialization takes place after a supply voltage is switched on or after the system 105 or the data bus 120 is reset.

The modules 110, 115 each comprise designations for connected lines or signals. The supply lines 130 are designated VBUS and GND. Data lines of the data bus 120 are designated D+ and D−. If the signal line 125 is interpreted as a current flowing from the primary module 110, CIC_OUT designates a connection to a downstream module 115 and CIC_IN designates a connection to an upstream module 110, 115.

FIG. 2 shows a secondary module 115 in a preferred embodiment. The secondary module 115 comprises an input 205 and an output 210 for the signal line 125. The input 205 can be connected to a line which carries the signal CIC_IN and the output 210 can be connected to a line which carries the signal CIC_OUT. Furthermore, a first switch 215, a second switch 220, a transistor 225 and a processing facility 230 are provided. It is to be noted that the second switch 220 and/or the transistor 225 can also be omitted in a simple embodiment of a technique described herein.

The switches 215 and 220 are coupled to each other and can be moved into a first or a second position on the basis of a signal CF_COMPLETE. If the secondary module 115 or the processing facility 230 is not yet initialized, the switches 215, 220 are preferably controlled into the illustrated first position. The switches 215 and 220 are preferably designed by means of semi-conductors, for example transistors or circuits having at least one transistor.

In the first position, an initialization signal CS which is received from the primary module 110 via the input 205 can be forwarded to the processing facility 230 in order to cause this to perform an initialization.

If the initialization is completed, the processing facility 230 of the secondary module 115 can move the switches 215, 220 into the second position. By switching the first switch 215 over, the input 205 is connected to the output 210 so that the signal line 125 is effectively extended as far as the following secondary module 115. At the same time, the input 205 is separated from the processing facility 230, so that an initialization signal arriving at the input 205 is not evaluated by the local processing facility 230 but is forwarded to the following secondary module 115 via the output 210.

In the second position, the second switch 220 is closed. The processing facility 230 can provide an interrupt request INT in order to close the transistor 225. The transistor 225 functions in the manner of a switch in an open collector circuit and acts on the signal line 125 running through the secondary module 115. The signal line 125 can be connected by the transistor 225 to a predetermined electrical potential, in the illustrated embodiment to ground. As a result, the level of the signal line 125 for all modules 110, 115 can be a recognizable 0 V. A module 110, 115 provided for this purpose, usually the primary module 110, can recognize this level or a transition (flank) to this level, interrupt a usual operation of the system 105 and process the interrupt request.

In the illustrated embodiment, the transistor 225 acts on the output 210. An interrupt request can only be transmitted in the direction of the primary module 110 if the first switch 215 is in the second position. By using the optional second switch 220, which separates the transistor 225 in the first position from the processing facility 230, it is possible to prevent a downstream secondary module 115 receiving an interrupt request of the processing facility 230 while the first switch 215 is in the first position. If the primary module 110 is provided for processing the interrupt request, the second switch 220 can also be omitted. In a yet further embodiment, the transistor 225 can also act on the input 205 rather than on the output 210 so that an interrupt request can also be output during the initialization of the secondary module 115.

FIG. 3 shows a flow diagram of a method 300 for controlling a system 105. Method steps which are shown in a left-hand column are usually executed by the primary module 110. Method steps in a right-hand column are assigned to a secondary module 115. It is to be noted that for multiple secondary modules 115, the same steps of the right-hand column can be executed in succession in each case. Steps 305 and 365 shown between the columns can apply for the entire system 105.

The system 105 is uninitialized in step 305. This condition prevails, for example, immediately after switch-on or during a reset. In step 310, the secondary module 115 can open the signal line 125 by moving its first switch 215 into the first position. At the same time, the primary module 110 can be initialized in step 315.

In step 320, the primary module 110 can output an initialization signal via the signal line 125. In this case, a secondary module 110 is preferably not addressed. At this point in time, only the particular secondary module 115 which directly follows the primary module 110 along the signal line 125 evaluates the initialization signal in step 325.

In step 330, the secondary module 115 can acknowledge the initialization signal to the primary module 110. The primary module 110 can receive the acknowledgement signal in step 325 and communicate with the secondary module 115. In this case, parameters are exchanged between the modules 110, 115 in step 335. The secondary module 115 can be initialized in step 340.

If the initialization is complete, the secondary module 115 can close the signal line 125 (in step 345) by moving its first switch 215 into the second position. In addition, it can report in step 350 the completion of its own initialization to the primary module 110.

If the primary module 110 receives in step 355 the confirmation, it can return to step 320 and send a further initialization signal via the signal line 125. The further initialization signal arrives at the next downstream secondary module 115 which can subsequently be likewise initialized in the described manner.

If one of the secondary modules 115 does not respond to the initialization signal sent by the primary module 110 in step 320, this allows a timeout to be detected in step 360. It can subsequently be determined in step 365 that the system 105 is completely initialized or that it is not possible to initialize a further secondary module 115. The initialization of the system 105 is consequently complete and normal operation can be resumed. This determination is preferably performed by means of the primary module 110. Step 365 can also be executed if a predetermined number of secondary modules 115 have reported their initialization to the primary module 110.

At this point in time, all the first switches 215 of the secondary modules 115 should each be in the second position and connect the respective input 205 of the secondary module 115 to its output 210. The primary module 110 can connect the signal line 125 to a predetermined electrical potential, for example a predetermined positive voltage which can be several volts. For this purpose, a voltage source can be provided at the first module 110.

In step 370, the primary module 110 or a secondary module 115 can connect the signal line 125 to another electrical potential, usually to a lower potential. The other potential is preferably connected to the signal line 125 with a higher impedance than the first potential. The connection allows the potential effective at the signal line 125 to be changed, and the change can be detected and evaluated by one of the modules 110, 115. In the illustrated embodiment, an evaluation is preferably performed in step 375 by the primary module 110, in another embodiment the evaluation can also be performed by a secondary module 115 or by multiple modules 110, 115.

Subsequently, the interrupt request can be processed by the evaluating module 110, 115. For this purpose, it is possible to change or suspend a function of a secondary module 115. If the interrupt request were to indicate a catastrophic event, for example, the modules 110, 115 could limit or switch off their functions. Thus, individual parts of an appliance or motor vehicle 100 can be shut down gracefully. Optionally, the system 100 can be completely reinitialized. For this purpose, an appropriate message can be sent from an evaluating module 110, 115 to all other modules 110, 115.

Reference characters

| | |
|---|---|
| 100 | Appliance |
| 105 | System |
| 110 | Primary module |
| 115 | Secondary module |
| 120 | Data bus |
| 125 | Signal line |
| 130 | Supply line |
| D+, D− | Data lines of the data bus 120 |
| VBUS, GND | Supply line 130 |
| CIC_IN | Input |
| CIC_OUT | Output |
| 205 | Input |
| 210 | Output |
| 215 | First switch |
| 220 | Second switch |
| 225 | Transistor |
| 230 | Processing facility |
| INT | Signal: interrupt request |
| CF_COMPLETE | Signal: initialization completed |
| CS | Signal: initialization |
| 300 | Method |
| 305 | Reset |
| 310 | Open daisy chain |
| 315 | Initialize |
| 320 | Send signal |
| 325 | Receive signal AND not |
| | yet initialized? |
| 330 | Acknowledge signal |
| 335 | Exchange parameters |
| 340 | Initialize |
| 345 | Close daisy chain |
| 350 | Confirm initialization |
| 355 | Receive confirmation |
| 360 | Timeout |
| 365 | System initialized |
| 370 | Request interruption |
| 375 | Process interruption |

1-12. (canceled)

13. A method for initializing a system including a primary electronic module and at least one secondary electronic module, the at least one secondary electronic module being connected to the primary electronic module by a signal line formed as a daisy chain, the method comprises the following steps:
a) opening the signal line in the at least one secondary electronic module;
b) providing an initialization signal on the signal line through the primary electronic module;
c) initializing one secondary electronic module receiving the initialization signal and not yet being initialized;
d) closing the signal line through a last initialized secondary electronic module; and
e) repeating steps b) to d) until all secondary electronic modules are initialized.

14. The method according to claim 13, which further comprises including a communication with the primary electronic module in the initialization of the secondary electronic module.

15. The method according to claim 14, which further comprises updating a software component of the secondary electronic module from the primary electronic module.

16. The method according to claim 14, which further comprises connecting the at least one secondary electronic module to the primary electronic module by a data bus, and carrying out communication over the data bus.

17. The method according to claim 14, which further comprises terminating the initialization when, during a predetermined time period after providing the initialization signal, no communication occurs between the primary electronic module and the secondary electronic module which is not yet initialized.

18. The method according to claim 14, which further comprises using the communication to transmit a configuration from the secondary electronic module to the primary electronic module, causing the primary electronic module to determine a topology of the at least one secondary electronic module in the system, based on received configurations.

19. The method according to claim 14, which further comprises once all electronic modules are initialized, using one of the electronic modules to connect the signal line to a predetermined potential in order to provide an interrupt request.

20. An electronic module, comprising:
an output for connection to a signal line formed as a daisy chain; and
a processing facility configured to provide an initialization signal over the signal line to at least one further electronic module.

21. An electronic module, comprising:
an input and an output for a signal line formed as a daisy chain;
a switch connected between the input and the output; and
a processing facility configured, upon the switch being open, to detect an initialization signal at the input, to initialize the electronic module, and to close the switch.

22. The electronic module according to claim 21, which further comprises a further switch for connecting the signal line to a predetermined potential in order to provide an interrupt request.

23. A system, comprising:
a signal line formed as a daisy chain;
a primary electronic module including an output for connection to the signal line, and a processing facility configured to provide an initialization signal over the signal line to at least one further electronic module; and
at least one secondary electronic module including an input and an output for the signal line, a switch connected between the input and the output, and a processing facility configured, upon the switch being open, to detect an initialization signal at the input, to initialize the electronic module, and to close the switch;
the signal line connecting the at least one secondary module to the primary module.

24. An electrical appliance, comprising the system according to claim 23.
